(19) United States
(12) Patent Application Publication
(10) Pub. No.: US 2013/0124970 A1
(43) Pub. Date: May 16, 2013

(54) NEWS RECAPPING

(71) Applicants: Hatem Zeine, Redmond, WA (US); Guy Friedel, Seattle, WA (US); Meir Shmouely, Kirkland, WA (US)

(72) Inventors: Hatem Zeine, Redmond, WA (US); Guy Friedel, Seattle, WA (US); Meir Shmouely, Kirkland, WA (US)

(73) Assignee: MICROSOFT CORPORATION, Redmond, WA (US)

(21) Appl. No.: 13/296,400

(22) Filed: Nov. 15, 2011

(51) Int. Cl. G06F 17/00

(52) U.S. Cl. 715/234

(57) ABSTRACT

Various embodiments pertain to techniques for providing a website recap. In some embodiments, a difference between a previously loaded version of the website and a current version of the website is created and utilized to select web pages or content items for display to a user. For example, if the website is a news website, when a user has not accessed the website over a weekend, articles regarding important news from the weekend can be displayed as links to the user when he or she visits the website on Monday morning. In various embodiments, the difference between a previously loaded version of the website and a current version of the website is created by ascertaining information regarding a previous request for the website by the user, such as a time of the previous request, and identifying content items published since that time.

### BACKGROUND

Many news websites classify news articles according to content subject (e.g., politics, sports, entertainment, etc.), sometimes adding featured categories to cover breaking news or stories of global importance. In addition to categorizing the news articles by content, websites often present news stories and updates to users with a greater emphasis on more recent articles than on articles published earlier in the day or week. As the websites replace their contents with fresh articles, older stories, despite being possibly important, are deprioritized in favor of newer, though possibly frivolous, stories.

Despite attempts to maintain important news articles on the website, a user who does not visit the website for an extended period of time (e.g., over the weekend or during a vacation) may miss out on important news, such as a story that breaks on Friday afternoon, but has been replaced by another big story by Monday morning. However, a user who visits the website several times a day may grow tired of seeing the same article each time he or she visits the website and may start visiting other news websites to obtain access to a variety of stories.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to techniques for providing a website recap. In some embodiments, a difference between a previously loaded version of the website and a current version of the website is created and utilized to select content items (e.g., web pages) for display to the user. For example, assuming the website is a news website, when a user has not accessed the website over a weekend, articles regarding important news from the weekend can be displayed as links to the user when he or she visits the website on Monday morning.

In various embodiments, content items selected for display to a user via inclusion on a web portal are associated with one or more dimensional values that are representative of a possible impact on a user. Dimensions can include space (e.g., available space on the web portal), time (e.g., an amount of time that has passed since the content item was published), an absolute importance of the content item, a subject area to which the content item relates, keywords included in the content item, a date the content item was published, and a date of removal of the content item, to name just a few. In some embodiments, user preferences can be used to determine a dimensional value related to a relevance of the content item to the user. Once various dimensional values are assigned to a content item, content items are prioritized according to the dimensional values for inclusion on the web portal. In various embodiments, a priority of a content item is adjusted based upon a user's viewing or otherwise interacting with the content item.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 illustrates an example operating environment in accordance with one or more embodiments;

FIG. 2 illustrates an example web portal in accordance with one or more embodiments;

FIG. 3 shows a flow diagram of an example process for adjusting content included on a web portal based on dimensions including time since a user's last visit to the web portal in accordance with one or more embodiments; and

FIG. 4 illustrates an example device that can be used to implement one or more embodiments.

### DETAILED DESCRIPTION

Overview

Various embodiments pertain to techniques for providing a website recap. In some embodiments, a difference between a previously loaded version of the website and a current version of the website is created and utilized to select web pages or content items for display to the user. For example, if the website is a news website, when a user has not accessed the website over a weekend, articles regarding important news from the weekend can be displayed as links to the user when he or she visits the website on Monday morning. In various embodiments, the difference between a previously loaded version of the website and a current version of the website is created by ascertaining information regarding a previous request for the website by the user, such as a time of the previous request, and identifying content items published since that time.

In various embodiments, content items selected for display to a user on a web page, such as a web portal, are associated with one or more dimensional values that are representative of a possible impact on a user, also sometimes referred to as user relevance. Dimensions can include space (e.g., available space on the web portal), time (e.g., an amount of time that has passed since the content item was published), an absolute importance of the content item, a subject area to which the content item relates, keywords included in the content item, a date the content item was published, and a date of removal of the content item, to name just a few. In some embodiments, user preferences can be used to determine a dimensional value related to a relevance of the content item to the user. Once various dimensional values are assigned to a content item, the content items are prioritized according to the dimensional values for inclusion on the web portal. In various embodiments, a priority of a content item is adjusted based upon a user's interaction with the web page, such as viewing the web page to which a hyperlink leads.

In the discussion that follows, a section entitled “Example Operating Environment” describes an operating environment in accordance with one or more embodiments. Next, a section entitled “Example Embodiments” describes various embodiments of providing a news recap on a website. In particular, adjusting a priority of a web page based on various dimensions is described. A subsection entitled “Prioritizing Content” describes various embodiments of determining a priority based on various dimensions. Finally, a section entitled “Example System” describes an example system that can be used to implement one or more embodiments.

Consider now an example operating environment in accordance with one or more embodiments.

Example Operating Environment

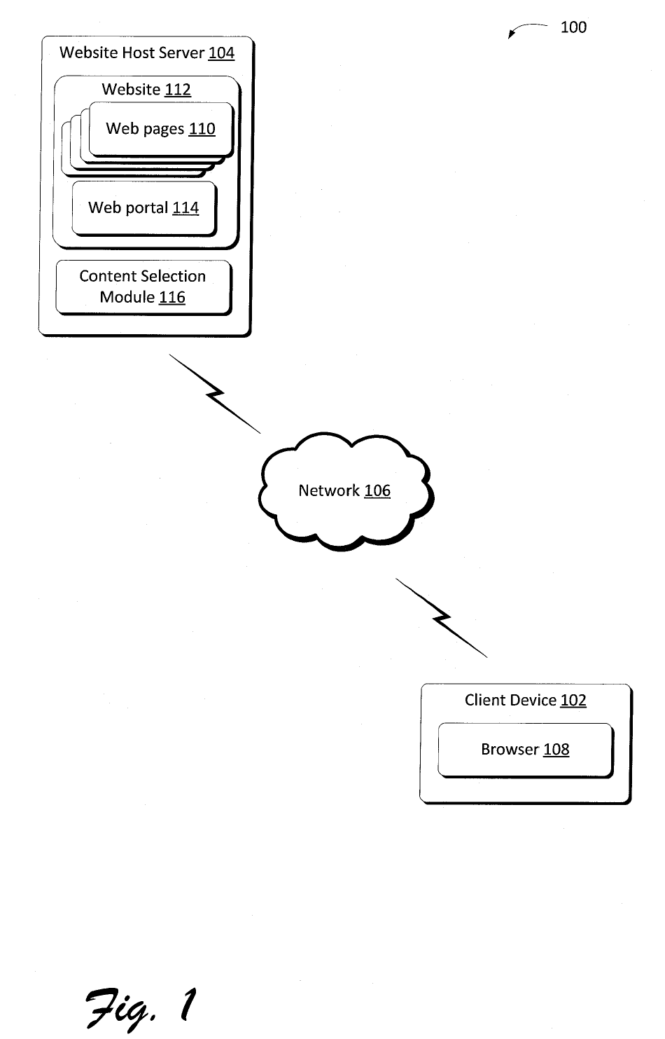

FIG. 1 is an illustration of an example environment 100 in accordance with one or more embodiments. Environment 100 includes a client device 102 and a website host server 104 in communication through network 106, such as the Internet. Client device 102, through a browser 108, can send a request for one or more web pages 110 of a website 112 hosted by the website host server 104. Responsive to receiving the request, website host server 104 can send information regarding one or more of the web pages 110 to the client device 102 via network 106.

Client device 102 can be embodied as any suitable computing device such as, by way of example and not limitation, a desktop computer, a portable computer, a netbook, a handheld computer such as a personal digital assistant (PDA), a cell phone, and the like. Client device 102 includes one or more software applications, which can include a software executable module in the form of a web browser 108. Browser 108 can receive content from and send content to other servers, such as website host server 104, via network 106, such as the Internet. Such content can include any suitable type of content that can be received from and sent to websites hosted by servers. In various embodiments, browser 108 is configured to send a request for a web page to a website host server 104 and cause a web page from the website host server 104 to be displayed to a user via client device 102.

Website host server 104 hosts one or more web pages 110, which together make up a website 112. In various embodiments, website 112 is a news website or a news-related section of another, larger website, and each of the web pages 110 include news articles. It is to be understood that while various embodiments will be described with reference to news articles, it is contemplated that the techniques described can be used with regard to any types of web pages and content. In some embodiments, website host server 104 hosts web pages 110 that include links to news articles on web pages hosted on other servers. In addition to web pages 110, website 112 includes a web portal 114 that functions as a point of access to web pages 110 and web pages hosted by other servers.

In various embodiments, web portal 114 can be a web page including links to other web pages, including those hosted by website host server 104 and other servers. In some embodiments, web portal 114 can organize the links by category (e.g., sports, politics, entertainment, health, etc.,) to enable users to efficiently navigate the portal. In addition to links, web portal 114 can include short snippets or abstracts of the content to provide a user with an idea about where the link will lead or what the content item is about. Links and other content items to be included on web portal 114 are selected by content selection module 116.

Content selection module 116 can select content items, such as links to web pages, for inclusion on web portal 114 based on a variety of factors or dimensions. Dimensions can include, by way of example and not limitation, available space on the web portal, space associated with displaying the content item, time (e.g., an amount of time that has passed since publication of the content item), an absolute importance of the content item, a subject area to which the content item relates, keywords included in the content item, a date the content item was published, and a date of removal of the content item, to name just a few. Other dimensions can be considered depending on the particular embodiment. For example, user preferences can be used to determine a relevance of the content item to the user. Content selection module 116 can assign values for each dimension considered for a given content item, and prioritize the content items according to the dimensional values. Content items can be included on the web portal in order of priority. In various embodiments, content selection module 116 considers content items that have been published since the client device last requested a page from website host server 104.

In various embodiments, the priority for a content item can be adjusted responsive to a user's interaction with the content item. For example, if a user selects a link on the web portal to a web page or otherwise views that web page, the web page's priority can be decreased in priority upon a user's subsequent visit to the web portal to enable links to different web pages to be included on the web portal for display to the user. Techniques for determining the priority of a web page are described in additional detail below.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

With example environment 100 in mind, consider now a discussion on providing a website recap in accordance with one or more embodiments.

Example Embodiments

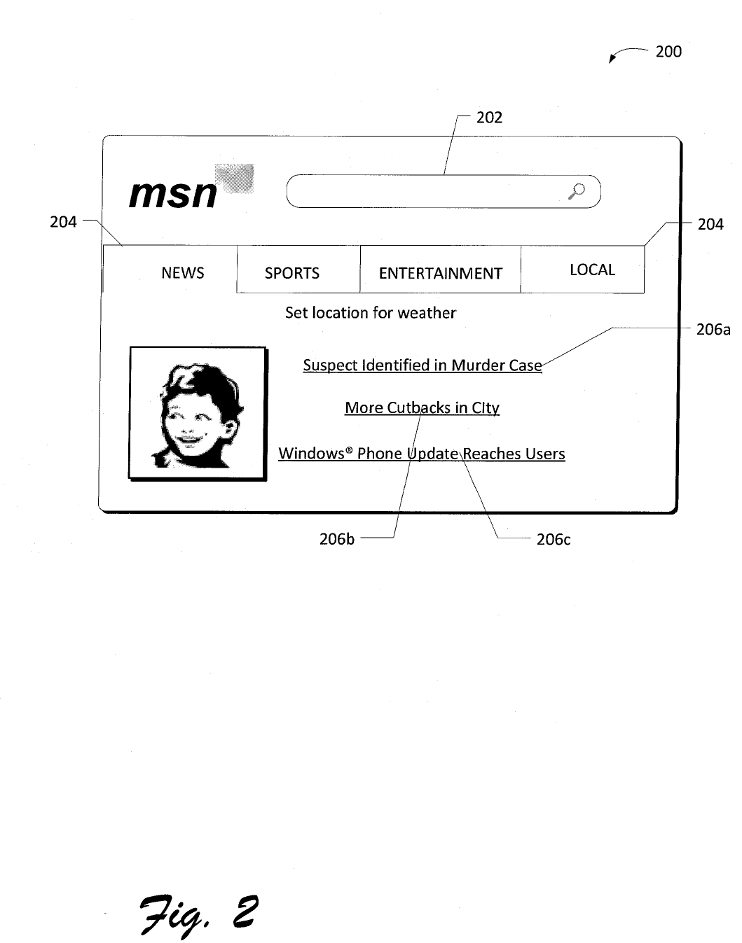

FIG. 2 illustrates an example web portal 200 in accordance with one or more embodiments. While particular features included on a web portal can vary, web portal 200 includes a search bar 202, various tabs 204, and links, such as link 206a, link 206b, and link 206c.

As briefly described above, a content selection module can select one or more links to be included for display on web portal 200. The number of links that can be displayed can vary depending on the particular embodiment. In addition to selecting links, the content selection module can also select various advertisements, images, graphics, multi-media components, or the like for inclusion on the web portal.

In various embodiments, the content selection module can adjust content (including links) included on the web portal 200 based on a user's interacting with the content. For example, if a user selects link 206a on web portal 200, an associated browser can be navigated to a web page containing a news article. When the user subsequently returns to web portal 200 after reading the article, the content selection module can decrease the priority of the web page corresponding to link 206a to enable links to different web pages to be included on web portal 200 for display to the user. In some embodiments, link 206a will not be included on web portal 200 during subsequent visits to the web portal by the user, or it can be placed below link 206b and link 206c, depending on the adjusted priority.

A user's subsequent visit to web portal 200 can be immediately following reading an article on the web page corresponding to link 206a (e.g., such as through the use of a “back” button on a user's web browser or through a link returning the user to the web portal), or it can be hours or days after the user has interacted with the content. For example, the user may visit web portal 200 upon arriving at work and read various articles, but then may not return to web portal 200 until just before leaving work for the day. In this case, links to content that the user interacted with in the morning can be given a decreased priority, enabling the user to more quickly determine what new content was added to web portal 200 during the time the user was away.

While various embodiments describe decreasing a priority of a web page or content item when a user has interacted with it (e.g., by clicking a link associated with the web page on the web portal), in other embodiments, the priority of content items initially associated with a high priority relative to priorities of other content items can be increased or maintained over a period of time. For example, if a user visits web portal 200 on Friday afternoon but then does not visit web portal 200 again until Monday morning, content items that would have been displayed on web portal 200 over the weekend with relatively high priorities (e.g., important news stories) can be included on the web portal 200 when the user returns to provide the user with a news recap for the weekend. Various processes for adjusting content included on a web portal can be implemented, depending on the particular dimensions included in assigning a priority.

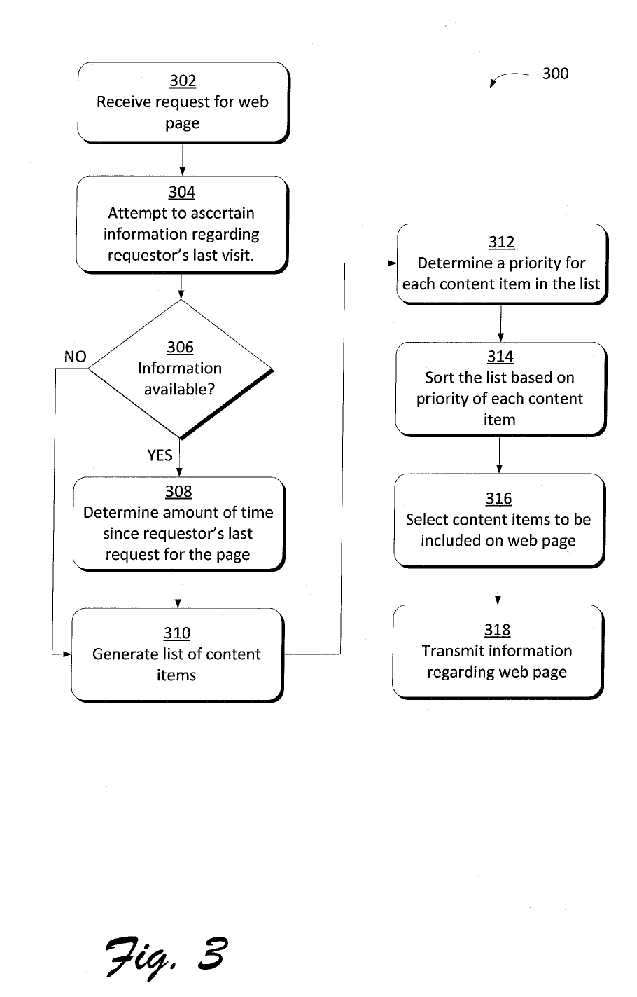

FIG. 3 describes an example process 300 for adjusting content included on a web portal based on dimensions including time since a user's last visit to the web portal in accordance with one or more embodiments. The process can be implemented in connection with any suitable hardware, software, firmware, or combination thereof. In at least some embodiments, the process can be implemented in software.

Block 302 receives a request for a web page. This can be performed in any suitable way. For example, website host server 104 can receive a request for web portal 114 via network 106.

Next, block 304 attempts to ascertain information regarding the requestor's last visit. This can be performed in any suitable way. For example, website host server 104 can detect a cookie stored on client device 102 that includes information regarding the requestor's last visit. The information can be, for example, information regarding the date and time of the last visit to the web portal by the client device, a duration of the visit, and the like. Alternatively or additionally, the information can be associated with a user's log-in credentials so that the techniques can be applied for a particular user accessing the website with different computing devices.

Decision block 306 determines if information is available. If information is available, block 308 determines an amount of time since the requestor's last request for the web page. This can be performed in any suitable way. For example, website host server 104 can calculate an amount of time since the requestor's last visit based on information stored in a cookie regarding a date and/or time of a previous request for the web portal 114. Alternatively or additionally, the website host server 104 can calculate an amount of time since the requestor's last visit based on a user's log-in credentials.

Next, block 310 generates a list of content items. This can be performed in any suitable way. For example, website host server 104 can search a database of content available for inclusion on web portal 114 and web pages 110. In embodiments in which block 308 determined an amount of time since the requestor's last request for the page, block 310 can generate a list of content items that have been published between the time of the last request for the web portal and the request received by block 302. For example, if block 308 determines that a user has not requested the web portal for five days, block 310 can generate a list of all content items that have been published during those five days.

Alternately, if block 306 determines that no information is available, block 310 can generate a list of content items available, such as a list of content items that have been published within a pre-determined amount of time. The amount of time can vary depending on the particular embodiment, and can be within a range in which content items will still be considered news-worthy.

Block 312 determines a priority for each content item in the list. This can be performed in any suitable way. For example, website host server 104 can assign a priority to each content item in the list according to a priority equation. But one example of a priority equation will be described in additional detail below.

Block 314 sorts the list based on the priority of each content item. This can be performed in any suitable way. For example, content items with higher priorities relative to the priorities of other content items can be ranked above those other content items, resulting in a list in which content items with the highest priorities appear first in the list, and content items with the lowest priorities appear later in the list.

Block 316 selects content items to be included on the web page. This can be performed in any suitable way. For example, the website server can determine that links to the top N content items are to be included on web portal 114. In other embodiments, content items can be selected according to a category. For example, links to the top X sports articles, links to the top Y world news articles, and links to the top Z entertainment articles can be included on web portal 114.

Block 318 transmits information regarding the web page. This can be performed in any suitable way. For example, website host server 104 can transmit information, such as code executable to cause a browser to render web portal 114, to client device 102. In various embodiments, the information regarding the web page can provide a news recap to the user, since important stories since the user's last visit will be included on the web page.

Process 300 describes embodiments of presenting content items to a user based on a user's last visit to the web page. However, various embodiments can consider other dimensions in addition to or separated from the last time the user visited the web page when determining which content items should be included on the web page. Such additional dimensions can be utilized, for example, when a priority is determined for each content item.

Prioritizing Content

In embodiments described above and below, content items are selected for inclusion on a web page, such as a web portal, based at least in part on a priority assigned to each content item and how that priority compares to the priorities of other content items that are available. The priority assigned to each content item can take into account various factors or dimensions, depending on the particular embodiment.

Some dimensions that can be considered include, by way of example and not limitation, a content item's absolute importance, a subject area to which the content item relates, keywords included in the content item or metadata corresponding to the content item, a date the content item was published, a date the content item was removed, user preferences, space associated with displaying the content item, and the like. Values for each of the dimensions for a particular embodiment are assigned for each content item. A content item's absolute importance can be, for example, based on a scale that includes various levels where a higher level is indicative of a higher importance. For example, a news article regarding the passing of a notable person can be assigned a high absolute importance value while a video of a dog doing a trick can be assigned a low absolute importance value.

In various embodiments, the age of a content item can be considered when assigning a priority to a content item. In some embodiments, as a content item ages, the priority assigned to it decreases. For example, news articles that were published recently can be more significant than news articles that were published earlier in the week or last month. To account for this decay in priority due to an aging content item, in various embodiments, the age of a content item can be measured in time (e.g., hours or days) since publication of the content item.

Furthermore, user preferences can influence the priority assigned to content items. User preferences can be obtained in various ways, such as via an identifiable account or a logged-in status of a user on a web-based service. User preferences can enable the system to assign higher priorities to content items in a specific category (e.g., sports or local news) when a user has indicated that he or she is particularly interested in that category of information. A user can also indicate a preference for certain types of content items (e.g., articles or videos) over another type of content item, or a preference for a source of content items (e.g., items obtained from a news wire versus items obtained from user blogs). User preferences can also be derived, for example, from keywords included in a content item viewed by a user that are associated with other content items. For example, when a user reads an article regarding a hurricane, that article itself may be decreased in priority, but other articles relating to the hurricane can be given an increased priority to enable the user to continue following the story.

Once values for each of the dimensions to be considered are assigned, a user significance or user relevance can be determined. In various embodiments, the priority of the content item is equal to the user significance of the content item. This can be done in any suitable way. For example, if each content item has a value for each of age, relevance, and importance, a user significance can be represented according to a function,

U=f(R,I,A)

where U is a user significance, R is a relevance of the content item, I is an importance of the content item, and A is an age of the content item represented in time since the content item was published. Relevance can be, for example, a sum of the values for dimensions such as a subject area to which the content item relates and keywords included in the content item or metadata corresponding to the content item. In various embodiments, relevance can represent the relevance of a content item in the user's interests, determined in any suitable way. Importance can be, for example, a value for an absolute importance of the content item that is representative of the significance of the content item in the global media. In various embodiments, when a user has already viewed the content item, the importance is decreased. Time can be in hours or days, depending on the particular embodiment. In various examples, user significance can be represented according to an equation,

U=100R+10I−A

where U is a user significance, R is a relevance of the content item, I is an importance of the content item, and A is an age of the content item represented in time since the content item was published. Time can be in hours or days, depending on the particular embodiment.

In some embodiments, a user may indicate that he or she prefers content items to be displayed in order to keep the user “in the know.” In such embodiments, factors can be considered equally, rather than weighting the relevance and importance of the content item. For example, user significance can be represented according to an expression,

U=R+I−A

where U is a user significance, R is a relevance of the content item, I is an importance of the content item, and A is an age of the content item represented in time since the content item was published.

With the foregoing description of various embodiments of providing a website recap in mind, consider the following example of a system that can be used to implement one or more embodiments.

Example System

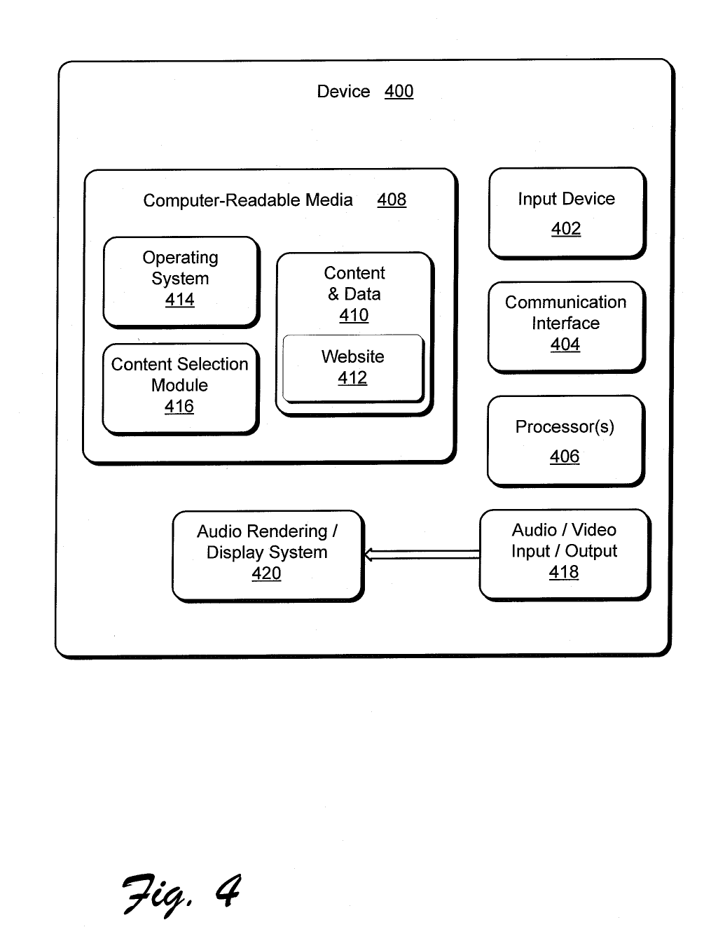

FIG. 4 illustrates various components of an example device 400 that can practice the embodiments described above. In one or more embodiments, device 400 can be implemented as a server, such as website host server 104 in FIG. 1.

Device 400 includes input device 402 that may include Internet Protocol (IP) input devices as well as other input devices, such as a keyboard. Device 400 further includes communication interface 404 that can be implemented as any one or more of a wireless interface, any type of network interface, and as any other type of communication interface. A network interface provides a connection between device 400 and a communication network by which other electronic and computing devices can communicate data with device 400. A wireless interface can enable device 400 to operate as a mobile device for wireless communications.

Device 400 also includes one or more processors 406 (e.g., any of microprocessors, controllers, and the like) which process various computer-executable instructions to control the operation of device 400 and to communicate with other electronic devices. Device 400 can be implemented with computer-readable media 408, such as one or more memory components, examples of which include random access memory (RAM) and non-volatile memory (e.g., any one or more of a read-only memory (ROM), flash memory, EPROM, EEPROM, etc.). A disk storage device may be implemented as any type of magnetic or optical storage device, such as a hard disk drive, a recordable and/or rewriteable compact disc (CD), any type of a digital versatile disc (DVD), and the like.

Computer-readable media 408 provides data storage to store content and data 410, as well as device executable modules and any other types of information and/or data related to operational aspects of device 400. Content and data 410 includes website 412, which can, in turn, include one or more web pages and/or a web portal. Website 412 can be, for example, website 112. One such configuration of a computer-readable medium is signal bearing medium and thus is configured to transmit the instructions (e.g., as a carrier wave) to the hardware of the computing device, such as via the network 106. The computer-readable medium may also be configured as a computer-readable storage medium and thus is not a signal bearing medium. Examples of a computer-readable storage medium include a random access memory (RAM), read-only memory (ROM), an optical disc, flash memory, hard disk memory, and other memory devices that may use magnetic, optical, and other techniques to store instructions and other data. The storage type computer-readable media are explicitly defined herein to exclude propagated data signals.

An operating system 414 can be maintained as a computer executable module with the computer-readable media 408 and executed on processor 406. Device executable modules can also include a content selection module 416 that operates as described above and below. Content selection module 416 can be, for example, content selection module 116.

Device 400 also includes an audio and/or video input/output 418 that provides audio and/or video data to an audio rendering and/or display system 420. The audio rendering and/or display system 420 can be implemented as integrated component(s) of the example device 400, and can include any components that process, display, and/or otherwise render audio, video, and image data.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable storage devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A computer-implemented method, comprising:
receiving, from a requestor, a request for a web page;
attempting to ascertain information regarding a previous request for the web page by the requestor;
generating a list of content items available for inclusion on the web page, the list of content items available comprising content items published since the previous request for the web page;
determining a priority for each content item in the list of content items available; and
selecting a plurality of content items based at least in part on the priority for each content item.

2. The computer-implemented method of claim 1, wherein determining a priority comprises determining a priority equal to a user significance of the content item, the user significance being represented according to a function
U=f(R,I,A)
where U is the user significance of the content item, R is a relevance of the content item, I is an importance of the content item, and A is an age of the content item represented in time since the content item was published.

3. The computer-implemented method of claim 1, selecting the plurality of content items comprising selecting a plurality of links, advertisements, images, graphics, multi-media components, articles, or combinations thereof.

4. The computer-implemented method of claim 1, wherein determining a priority comprises determining a priority based on one or more of at least space associated with displaying the content item, time since a publication of the content item, an absolute importance of the content item, a subject area to which the content item relates, keywords included in the content item, a date the content item was published, or a date of removal of the content item.

5. The computer-implemented method of claim 1, wherein attempting to ascertain information regarding a requestor comprises attempting to detect a cookie comprising information regarding the previous request for the web page.

6. The computer-implemented method of claim 1, wherein attempting to ascertain information regarding a requestor comprises attempting to ascertain information regarding a user's log-in credentials.

7. The computer-implemented method of claim 1, further comprising:
determining the requestor has interacted with a content item in the list of content items available;
identifying one or more content items in the list of content items available related to the content item with which the requestor interacted; and
increasing a relevance of the one or more content items related to the content item interacted with.

8. The computer-implemented method of claim 7, wherein determining the requestor has interacted with the content item comprises determining the requestor has viewed the content item.

9. One or more computer-readable storage media comprising instructions that are executable to cause a device to perform a process comprising:
receiving a request for a news portal;
attempting to ascertain information regarding a previous request for the news portal;
generating a list of articles available for inclusion on the news portal, the list of articles available comprising articles published since the previous request for the news portal;
determining a priority for each article in the list of articles; and
selecting a plurality of articles for inclusion on the news portal based on the priority for each article.

10. The one or more computer-readable storage media of claim 9, wherein determining the priority comprises determining the priority based on one or more of at least space associated with displaying the content item, time since a publication of the content item, an absolute importance of the article, a subject area to which the article relates, keywords included in the article, a date the article was published, or a date of removal of the article.

11. The one or more computer-readable storage media of claim 9, wherein determining the priority for each article comprises determining a priority equal to a user significance of each article, the user significance being represented according to an equation
U=R+I−A
where U is the user significance of the article, R is a relevance of the article, I is an importance of the article, and A is an age of the article represented in time since the article was published.

12. The one or more computer-readable storage media of claim 9, further comprising:
transmitting the news portal including a news recap.

13. The one or more computer-readable storage media of claim 12, wherein transmitting the news portal comprises transmitting the news portal and including a link to each of the plurality of articles selected for inclusion on the news portal.

14. The one or more computer-readable storage media of claim 9, further comprising:
determining a requestor of the news portal has viewed one or more articles in the list of articles available; and
removing viewed articles from the list of articles available.

15. The one or more computer-readable storage media of claim 9, further comprising:
determining a requestor of the news portal has viewed an article in the list of articles available;
identifying one or more articles in the list of articles available related to the viewed article; and
increasing a relevance of the one or more articles related to the viewed article.

16. The one or more computer-readable storage media of claim 9, wherein attempting to ascertain information regarding the previous request comprises attempting to detect a cookie comprising information regarding the previous request for the news portal.

17. The one or more computer-readable storage media of claim 16, further comprising:
determining a requestor of the news portal has viewed an article in the list of articles available;
identifying one or more articles in the list of articles available related to the viewed article; and
increasing a relevance of the one or more articles related to the viewed article.

18. A device comprising:
one or more processors;
one or more computer-readable storage media; and
one or more modules embodied on the one or more computer-readable storage media and executable under the influence of the one or more processors, the one or more modules configured to:
receive a request for a news portal;
attempt to ascertain information regarding a previous request for the news portal;
generate a list of articles available for inclusion on the news portal published since the previous request for the news portal;
determine a priority for each article in the list of articles; and
select a plurality of articles from the list of articles for inclusion on the news portal based on the priority for each article.

19. The device of claim 18, the one or more modules further configured to:
determine, based upon information regarding a previous request, a requestor of the news portal has viewed an article in the list of articles; and
remove the article viewed from the list of articles available.

20. The device of claim 19, the one or more modules further configured to:
identify one or more articles in the list of articles related to the article viewed; and
increase a relevance of the one or more articles related to the article viewed.
